(19) United States
(12) Patent Application Publication
(10) Pub. No.: US 2024/0401289 A1
(43) Pub. Date: Dec. 5, 2024

(54) RESILIENTLY IMPACTABLE BARRIER SYSTEMS

(71) Applicant: Rite-Hite Holding Corporation, Milwaukee, WI (US)

(72) Inventors: Jason T. Dondlinger, Bellevue, IA (US); Tony W. Duesing, Bellevue, IA (US); Nicholas John Casey, Cascade, IA (US); Aaron J. Wiegel, Benton, WI (US); Dillon David Schepers, Cascade, IA (US)

(21) Appl. No.: 18/731,003

(22) Filed: May 31, 2024

Related U.S. Application Data
(60) Provisional application No. 63/505,317, filed on May 31, 2023.
(60) Provisional application No. 63/597,436, filed on Nov. 9, 2023.

(51) Int. Cl. E01F 9/627

(52) U.S. Cl. CPC E01F 9/629

(57) ABSTRACT

Resiliently impactable barrier systems are disclosed. An example a barrier system comprises a shaft having a first end and a second end opposite the first end, an anchor to be positioned at the first end of the shaft, the anchor having an opening, the second end of the shaft to extend through the opening, the second end of the shaft to extend away from the anchor, a cup coupled to the second end of the shaft, the cup spaced apart from the anchor along a longitudinal axis of the shaft, and a shock absorbing body to engage with the shaft, the shock absorbing body enclosed by the anchor.

### RELATED APPLICATIONS

This patent claims the benefit of U.S. Provisional Patent Application No. 63/505,317, which was filed on May 31, 2023, and also claims the benefit of U.S. Provisional Patent Application No. 63/597,436, which was filed on Nov. 9, 2023. U.S. Provisional Patent Application No. 63/505,317 and U.S. Provisional Patent Application No. 63/597,436 are incorporated herein by reference in their entireties. Priority to U.S. Provisional Patent Application No. 63/505,317 and U.S. Provisional Patent Application No. 63/597,436 is claimed.

### FIELD OF THE DISCLOSURE

This disclosure relates generally to barrier systems and, more particularly, to resiliently impactable barrier systems.

### BACKGROUND

Bollards have been developed to absorb impact from vehicles (e.g., manufacturing equipment, cars, etc.). In some instances, a bollard can block (e.g., prevent) passage of such vehicles into a certain area, and thereby prevent impact and potential damage to other things (building structures, goods, equipment, people, etc.). Some bollards may be implemented in parking lots, roads, manufacturing floors, etc. Some bollards may be implemented within barrier systems. For example, barrier systems include one or more rails that extend horizontally between vertical bollards or posts.

### BRIEF DESCRIPTION OF THE DRAWINGS

FIG. 1 illustrates an example bollard constructed in accordance with teachings disclosed herein.

FIG. 2 is an exploded view of a first example implementation of the example bollard of FIG. 1.

FIGS. 3-5 are cross-sectional views of the example bollard of FIG. 2.

FIG. 6 is an exploded view of a second example implementation of the example bollard of FIG. 1.

FIG. 7 is a cross-sectional view of the example bollard of FIG. 6.

FIG. 8A is a cross-sectional view of an example first barrier constructed in accordance with teachings disclosed herein.

FIG. 8B is an enlarged view of a portion of the example first barrier of FIG. 8A.

FIG. 8C is a perspective view of an example cup and an example anchor included in the example first barrier of FIGS. 8A and 8B.

FIG. 8D is another perspective view of the example cup and the example anchor included in the example first barrier of FIGS. 8A and 8B.

FIG. 8E is yet another perspective view of the example cup and the example anchor included in the example first barrier of FIGS. 8A and 8B.

FIG. 8F is a perspective view of an example covering surrounding the example cup and the example anchor of FIGS. 8C-8E.

FIG. 8G is a detailed view of the example covering of FIG. 8F.

FIG. 9 is a cross-sectional view of an example second barrier constructed in accordance with teachings disclosed herein.

FIG. 10A is a perspective view of an example first barrier system including the example first barrier of FIG. 8A.

FIG. 10B is an exploded view of a portion of the example first barrier system of FIG. 10A.

FIG. 10C is a detailed view of the example first barrier system of FIGS. 10A and 10B.

FIG. 11A is an enlarged perspective view of another example barrier constructed in accordance with teachings disclosed herein.

FIG. 11B is a top view of the example barrier of FIG. 11A.

FIG. 12A is an enlarged perspective view of yet another example barrier constructed in accordance with teachings disclosed herein.

FIG. 12B is a top view of the example barrier of FIG. 12A.

FIG. 13A is a perspective view of an example second barrier system including the example second barrier of FIG. 9.

FIG. 13B is an enlarged view of a portion of the example second barrier system of FIG. 13A.

FIG. 14 is a perspective view of an example third barrier system including the example second barrier of FIG. 9.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts. Further, as used herein, stating that any part is directly adjacent to another part is defined to mean that the two elements are not necessarily touching but that they are in close proximity with no intermediate materials positioned therebetween.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

In some industrial environments, bollards may block vehicles or goods from entering or colliding with certain equipment, storage facilities, pedestrian spaces, other vehicles, etc. Further, bollards may be implemented within barrier systems (e.g., guard rail systems) having a plurality of spaced apart bollards (also referred to herein as barriers or posts) with horizontal rails extending therebetween. Many bollards include internal mechanisms for absorbing impact and/or resisting load. In some examples, bollards utilize shock absorbing (e.g., energy absorbing, dampening, etc.) material to resist impacts. Even though such example bollards may be able to slow or stop a moving vehicle upon impact, an impact can cause damage to the bollard or may render the bollard inoperable or less resilient (unable to withstand subsequent impacts). Similarly, the horizontal rails of barrier systems are composed of plastics and/or other materials that provide some flexibility or resilience in response to an impact. However, such materials are susceptible to shearing or deformation near the posts if an impact occurs near the center of the rails.

Examples disclosed herein utilize shock absorbing material and design to absorb or resist impact experienced by example bollards. Examples disclosed herein reduce the risk of damage to bollard systems by employing shock absorbing material that can contact a bollard shaft and/or an anchor of the bollard. Further, examples disclosed herein reduce the risk of damage to barrier systems by employing shock absorbing material to increase resiliency of barrier anchors. Examples disclosed herein utilize a shaft with a flange to distribute forces to other load bearing portions of the bollard (e.g., multiple shock absorbing bodies, the anchor, the shaft, etc.).

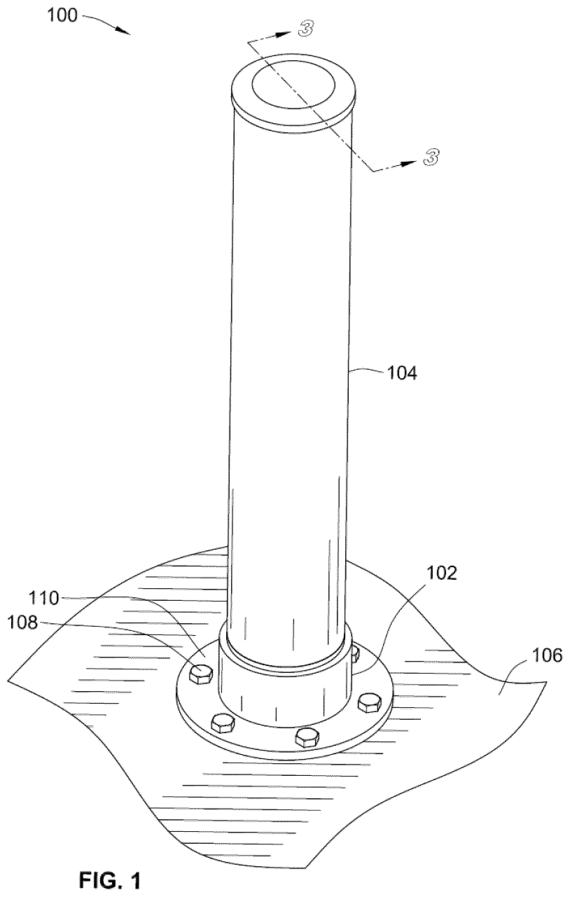

FIG. 1 illustrates an example bollard 100 constructed in accordance with teachings disclosed herein. The example bollard 100 includes an example anchor (e.g., housing, collar, baseplate, etc.) 102 and an example casing (e.g., covering) 104. As shown in FIG. 1, the example anchor 102 is couplable (e.g., mountable) to an example ground (e.g., ground surface, mounting surface, etc.) 106. Further, the example bollard 100 may be secured (e.g., mounted, anchored, etc.) to the ground 106 via screws 108. Additionally or alternatively, the example anchor 102 includes an example mounting flange 110 that may couple to the ground 106.

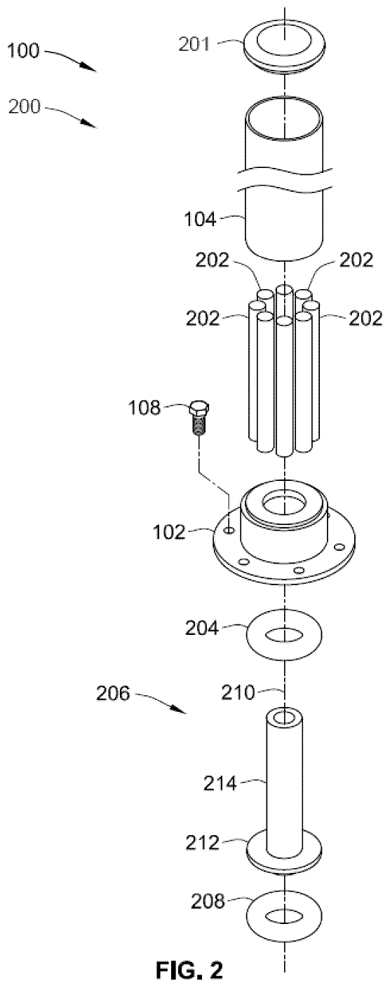

FIG. 2 illustrates an exploded view of a first example implementation 200 of the example bollard 100 of FIG. 1. As shown in FIG. 2, the example bollard 100 further includes an example cap 201, example elongate shock absorbing bodies (e.g., pillars) 202, an example shock absorbing body 204 (e.g., a first shock absorbing body, an upper shock absorbing body, etc.), an example shaft 206, and another example shock absorbing body 208 (e.g., a second shock absorbing body, a lower shock absorbing body, etc.). The example bollard 100 extends along an example axis 210 (e.g., center axis, longitudinal axis, longitudinal direction, etc.). In some examples, a center axis of the bollard casing 104 is generally aligned relative to a center axis of the shaft 206 and/or the axis 210. In some examples, the cap 201 is omitted. In some such examples, a top of the casing 104 is closed off. In some examples, the cap 201 is integrally formed with the casing 104.

The example shaft 206 includes an example flange (e.g., portion) 212 that surrounds an example outer surface (e.g., outer side wall) 214 of the shaft 206. As shown in FIG. 2, the example flange 212 is positioned on the outer surface 214. The example flange 212 extends (e.g., protrudes) away from the shaft 206 in a radial direction from a center axis of the shaft 206 and/or the axis 210. However, the example flange 212 may extend in any direction away from a center axis of the shaft 206, the axis 210, the outer surface 214 of the shaft 206, etc. In other words, the example flange 212 may protrude from the shaft 206 in a direction transverse to an elongate length of the shaft 206. Additionally or alternatively, the example flange 212 may include multiple separate portions. For example, a first portion of the flange 212 can be spaced apart from a second portion of the flange 212 in a direction extending circumferentially around the shaft 206. In such examples, the first portion of the flange 212 can extend in a first direction away from the outer surface 214 and the second portion of the flange 212 can extend in a second direction away from the outer surface 214, the second direction different from the first direction.

In FIG. 2, the example first and second shock absorbing bodies 204, 208 may be coaxially aligned to each other and/or aligned to the axis 210. As shown in FIG. 2, the second shock absorbing body 208 is closer to the bottom of the bollard 100 than the first shock absorbing body 204. Accordingly, for purposes of explanation, the first and second shock absorbing bodies 204, 208 are referred to herein as upper and lower shock absorbing bodies, respectively. The example upper and lower shock absorbing bodies 204, 208 may be annular rings (e.g., compressible rings). In some examples, the upper shock absorbing body 204 and/or the lower shock absorbing body 208 may have a generally spherical shape. That is, in some examples, rather than being one continuous ring (as shown), one or both of the upper and lower shock absorbing bodies 204, 208 may be implemented with multiple, discrete balls or spheres arranged to surround (e.g., at least partially surround) the shaft 206, the outer surface 214, the axis 210, etc. In some such examples, the discrete portions of the shock absorbing bodies 204, 208 may have a shape other than a sphere (e.g., cubes, cylinders (similar to the bodies 202), etc.). Additionally or alternatively, the example shock absorbing bodies 204, 208, can include generally circular cross sections. Thus, in some examples, the shock absorbing bodies 204, 208 are doughnut-shaped (e.g., a toroid with a circular cross-section). In other examples, the cross-sectional shape can be different (e.g., a square or rectangular, an oval shape, etc.). In the illustrated example, both the upper and lower shock absorbing bodies 204, 208 have the same size, shape, and design. However, in other examples, the size, shape, and/or design of the upper and lower shock absorbing bodies 204, 208 can differ. In some examples, shock absorbing bodies 204, 208 can include multiple assembled or stacked elements (e.g., rings or doughnuts). These elements can be of the same or different shapes and made of the same or different materials.

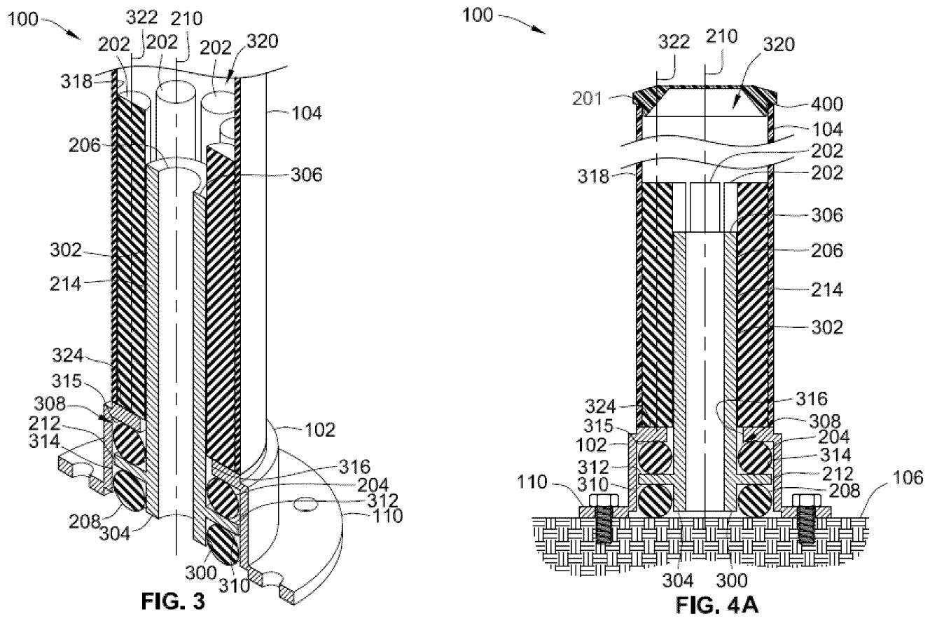

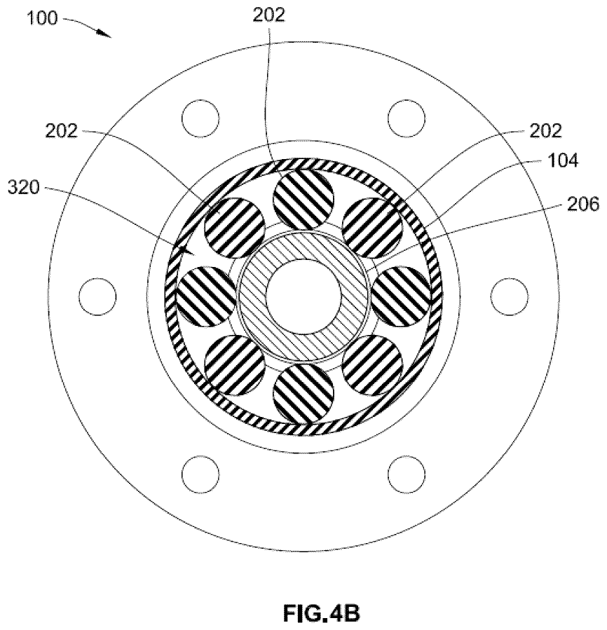

FIGS. 3-4B are cross-sectional views of the example bollard 100. The example shaft 206 includes a first portion 300 that extends in a first direction from the flange 212 to a first end 304 of the shaft 206 and a second portion 302 that extends in a second direction from the flange 212 to a second end 306 of the shaft 206, the second direction different from the first direction. In this example, the first and second portions 300, 302 extend in a direction generally aligned to the center axis 210 of the shaft 206. In some examples, the first and second portions 300, 302 can extend along direction(s) transverse (e.g., at an angle) to the center axis 210.

The example flange 212 is positioned between the first end 304 of the shaft 206 and the second end 306 of the shaft 206 opposite the first end 304. In this example, the flange 212 is spaced apart from both of the ends 304, 306 of the shaft 206. Further, when the bollard 100 is assembled, the example anchor 102 is positioned at the first end 304 to enclose at least the flange 212, the first portion 300, and the first end 304. In particular, the example mounting flange 110 of the anchor 102 is adjacent to the first end 304 of the shaft 206. That is, in this example, the first portion 300 of the shaft 206 is shorter than the second portion 302 of the shaft 206. The example anchor 102 includes a cavity 308 to receive the flange 212 and the first end 304.

The example flange 212 includes a first surface (e.g., face) 310 that faces towards the first end 304 of the shaft 206 and a second surface (e.g., face) 312 that faces in the opposite direction (e.g., towards the second end 306 of the shaft 206). The example lower shock absorbing body 208 is to be at least partially positioned between the first surface 310 of the flange 212 and the first end 304. Further, the example lower shock absorbing body 208 can be positioned closer to the first end 304 than the flange 212 is to the first end 304 (e.g., adjacent the first portion 300 of the shaft 206). In some examples, the lower shock absorbing body 208 is to be in contact with the first surface 310 of the flange 212 and/or the first portion 300 of the shaft 206. Additionally or alternatively, the lower shock absorbing body 208 is to be positioned within the cavity 308 adjacent (e.g., directly adjacent) the outer surface 214 of the shaft 206. As such, the example lower shock absorbing body 208 can be arranged to at least partially surround (e.g., encircle) the outer surface 214, the first portion 300 of the shaft 206, the first end 304, etc.

In some examples, the lower shock absorbing body 208 is to be positioned between the first surface 310 and the ground 106. In some examples, an entirety of the example lower shock absorbing body 208 is to be closer to the ground 106 than the flange 212 is to the ground 106. As such, the example lower shock absorbing body 208 can separate the flange 212 from the ground 106. In other words, the example flange 212 does not engage with the mounting surface when the bollard 100 is mounted to the mounting surface (e.g., the ground 106). Further, in some examples, the lower shock absorbing body 208 has a thickness that is greater than a length of the first portion 300 of the shaft 206. As such, as mostly clearly shown in FIG. 4A, the lower shock absorbing body 208 extends beyond the first end 304 of the shaft 206 when the lower shock absorbing body 208 is in contact with first surface 310 of the flange 212.

In this example, example outer surfaces of the shock absorbing bodies 204, 208 contact an example side wall (e.g., inner wall, side surface, vertical side wall, inner surface, etc.) 314 of the anchor 102. The example upper shock absorbing body 204 is positioned between the second surface 312 of the flange 212 and the side wall 314 of the anchor 102. Additionally, the example upper shock absorbing body 204 contacts an upper surface 315 of the anchor 102 and the second surface 312 of the flange 212. As such, the upper shock absorbing body 204 separates the second surface 312 of the flange 212 from the upper surface 315 of the anchor 102. Further, the example upper shock absorbing body 204 can be positioned adjacent the outer surface 214 of the shaft 206 (e.g., along the second portion 306 of the shaft 206). The example flange 212 can be positioned between (e.g., separate) the upper shock absorbing body 204 and the lower shock absorbing body 208. Accordingly, in this example, the upper shock absorbing body 204 is entirely above (e.g., higher than, entirely separate from, etc.) the lower shock absorbing body 208. For example, a lowermost portion of the upper shock absorbing body 204 is entirely above an uppermost portion of the lower shock absorbing body 208.

The example anchor 102 encloses the first portion 300 of the shaft 206, the flange 212, the upper shock absorbing body 204, and the lower shock absorbing body 208. Additionally, the example anchor 102 includes an opening 316 to enable the second portion 302 of the shaft 206, including the second end 306, to protrude (e.g., extend) from the anchor 102. For example, the second portion 302 of the shaft 206 extends away from the anchor 102 along a longitudinal direction (e.g., the center axis 210) of the shaft 206. In some examples, the shaft 206 can extend any suitable distance above the anchor 102 (e.g., halfway up the height of the casing 104, less than halfway up the height of the casing 104, more than halfway the height of the casing 104, etc.).

In this example, a diameter (e.g., size) of the flange 212 is greater than a diameter of the opening 316. Accordingly, the size of the flange 212 prevents the flange 212 from fitting through the opening 316 during assembly and/or operation. The example upper shock absorbing body 204 may be positioned on the upper surface 312 of the flange 212 prior to positioning (e.g., feeding) the shaft 206 through the opening 316. As such, the example upper shock absorbing body 204 can be sandwiched between the upper surface 315 and the flange 212. Then, the example lower shock absorbing body 208 can be added to the example assembly. However, the example lower shock absorbing body 208 may be added to the assembly at any time prior to securing the bollard 100 to the ground 106.

The example casing 104 at least partially encloses (e.g., encloses, fully encloses, covers, etc.) the second portion 302 of the shaft 206. The outer surface 214 of the shaft 206 can be spaced apart from an example inner surface 318 of the casing 104 to define an example chamber 320 therebetween when the casing 104 surrounds the shaft 206.

Further, the example bollard 100 includes at least one of the elongate shock absorbing bodies 202 that separates (e.g., is positioned between) the second portion 302 of the shaft 206 and the inner surface 318 of the casing 104. For example, the elongate shock absorbing bodies 202 can fill at least a portion of the chamber 320 between the shaft 206 and the casing 104. In this example, the elongate shock absorbing bodies 202 are positioned to surround a perimeter (e.g., the outer surface 214) of the shaft 206. The example elongate shock absorbing bodies 202 may include longitudinal axes (e.g., an example longitudinal axis 322) that are offset (e.g., laterally offset, not coaxially aligned, etc.) from the center axis 210 of the shaft 206. For example, the elongate shock absorbing bodies 202 can be approximately parallel (e.g., within 5 degrees) and radially spaced with respect to the shaft 206. To that end, the example elongate shock absorbing bodies 202 may extend along an elongate length (e.g., a longitudinal direction) of the shaft 206. For example, at least one of the elongate shock absorbing bodies 202 can extend from an exterior surface (e.g., outer surface) 324 of the anchor 102 to the second end 306 of the shaft 206. In this example, the exterior surface 324 is adjacent to the opening 316. In some examples, at least one of the elongate shock absorbing bodies 202 can extend from the anchor 102 to an example end 400 of the casing 104 and/or the cap 201 of the casing 104. In some examples, the elongate shock absorbing bodies 202 can extend any suitable distance above the anchor 102 (e.g., halfway up the height of the casing 104, less than halfway up the height of the casing 104, more than halfway the height of the casing 104, etc.).

In this example, the elongate shock absorbing bodies 202 extend beyond the second end 306 of the shaft 206. However, the example elongate shock absorbing bodies 202 may not extend beyond the second end 306 of the shaft 206. In some examples, the second end 306 of the shaft 206 extends beyond the elongate shock absorbing bodies 202. In an example upright orientation of the example bollard 100, the length of one of the elongate shock absorbing bodies 202 can be longer than the length of the second portion 302 of the shaft 206. Additionally, the example elongate shock absorbing bodies 202 have a cylindrical shape and, thus, a generally circular cross-section. In other examples, the elongate shock absorbing bodies 202 may have a prismatic shape, a square shape, a rectangular shape, or any other suitable shape or cross-section. In FIGS. 3-4B, the example elongate shock absorbing bodies 202 are smaller in diameter than the diameter of the shaft 206. In some examples, the elongate shock absorbing bodies 202 may be larger in diameter than the diameter of the shaft 206. In some examples, the elongate shock absorbing bodies 202 are integrally formed to define a sleeve that extends continuously around the shaft 206.

FIG. 4B is a cross-sectional top view of the example bollard 100. As shown in FIG. 4B, the example elongate shock absorbing bodies 202 are positioned to surround the shaft 206. The example casing 104 encircles the elongate shock absorbing bodies 202. In FIG. 4B, the example chamber 320 is at least partially filled with the elongate shock absorbing bodies 202 such that the elongate shock absorbing bodies 202 are spaced apart. In some such examples, spacers (not shown) may be used to maintain the separation between adjacent elongate shock absorbing bodies 202 and/or assist in assembly or installation of the bollard 100. In some examples, the elongate shock absorbing bodies 202 may not be spaced apart. In such examples, the chamber 320 may be filled (e.g., packed, fully filled, etc.) by elongate shock absorbing bodies 202. For example, adjacent ones of the elongate shock absorbing bodies 202 may be in contact with (e.g., abutting) one another.

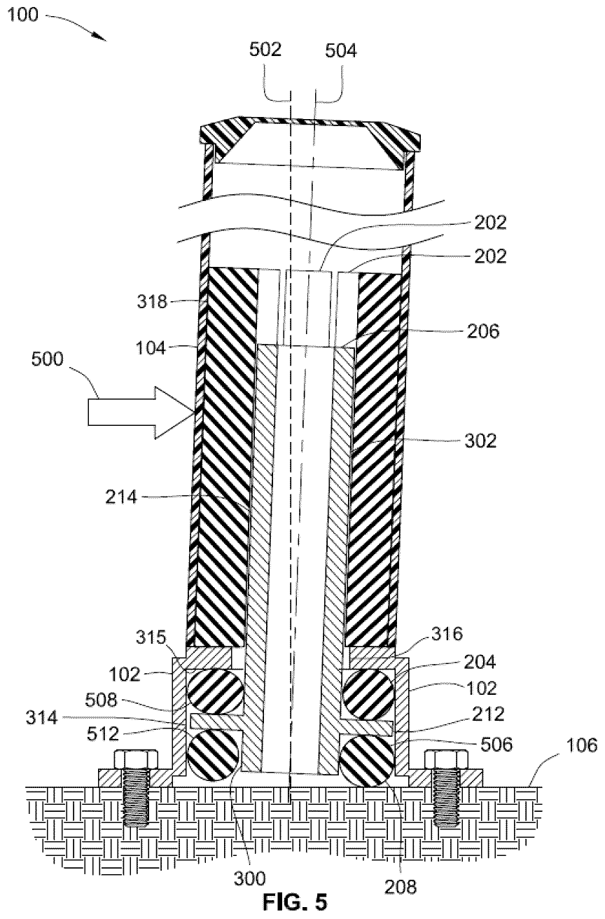

FIG. 5 illustrates a cross-sectional view of the example bollard 100. In this example, the bollard 100 is shown to be under impact, force, load, etc., along a direction as generally shown by an example force vector 500. The example the force impacting the bollard 100 causes a displacement of the example bollard 100. For example, prior to impact the example bollard 100 may have been generally aligned to a first example axis (e.g., upright axis) 502. After impact and/or during impact, the example bollard 100 is moved (e.g., leaned, titled, angled, shifted, etc.) to a second example axis (e.g., displaced axis) 504. In the example of FIG. 5, the elongate shock absorbing bodies 202 are approximately parallel to the axis 504 and the second portion 302 of the shaft 206. However, during operation the example elongate shock absorbing bodies 202 may be moved to different positions and/or angles relative to each other and/or the shaft 206.

The design and construction of the example bollard 100 provide several mechanisms to absorb impacts of various severities represented by the force vector 500. The elongate shock absorbing bodies 202 serve as the initial point of contact with an impact to the casing 104 and, therefore, the initial shock absorbing mechanism of the bollard 100. That is, for relatively small impact forces, the elongate shock absorbing bodies 202 may be able to deform (e.g., compress) to absorb the impact without significantly affecting the rest of the assembly. The example elongate shock absorbing bodies 202 may be made of compressible materials (e.g., natural rubber, polyurethane, polyethylene foam, closed cell foams, etc.) to enable such compression, deformation, resiliency, etc. In some examples, an outer surface of a first one of the elongate shock absorbing bodies 202 may engage with (be urged against) an outer surface of a second one of the elongate shock absorbing bodies 202 during an impact with the bollard 100. In such examples, the second one of the elongate shock absorbing bodies 202 supports and/or cushions movement of the first one of the elongate shock absorbing bodies 202. Further, the elongate shock absorbing bodies 202 are positioned to cushion the shaft 206 from contacting the casing 104. In some examples, the elongate shock absorbing bodies 202 engage with (e.g., contact) the outer surface 214 of the shaft 206 to resist and/or dampen movement of the shaft 206.

In some examples, the elongate shock absorbing bodies 202 may include materials that have a relatively high coefficient of friction such that adjacent ones of the elongate shock absorbing bodies 202 can grip (e.g., attach, adhere, stick, etc.) to one another and/or the casing 104. For example, an outer surface of at least one of the elongate shock absorbing bodies 202 can adhere to the inner surface 318 of the casing 104. The example outer surface of the at least one of the elongate shock absorbing bodies 202 resists movement of the casing 104 based on the friction between the outer surface of the at least one of the elongate shock absorbing bodies 202 and the inner surface 318. That is, during an impact the example casing 104 not only moves sideways but may also be urged upward (e.g., away from the anchor 102.) However, the relatively high friction surfaces of the elongate shock absorbing bodies 202 can reduce (e.g., eliminate) vertical movement of the casing 104.

In other examples, an outer surface of a first one of the elongate shock absorbing bodies 202 can adhere to an outer surface of a second one of the elongate shock absorbing bodies 202. The example outer surface of the second one of the elongate shock absorbing bodies 202 resists vertical movement of the first one of the elongate shock absorbing bodies 202 based on the friction between the outer surfaces of the first and second elongate shock absorbing bodies 202. As such, the elongate shock absorbing bodies 202 may engage with one another to distribute (e.g., counteract) force experienced by the shaft 206 and/or the bollard 100.

If the impact force is great enough, the force may be transferred through the elongate shock absorbing bodies 202 to the shaft 206. Such a force can cause the shaft 206 to shift or tilt as shown in FIG. 5. In this example, a size (e.g., diameter, width, etc.) of the flange 212 is less than a size of the cavity 308. As such, there may be a gap and/or clearance between the flange 212 and the side wall 314 to permit the shaft 216 to tilt. In some examples, the flange 212 may contact the side wall 314 of the anchor 102 such that the anchor 102 absorbs at least some of the impact force. However, as shown in FIG. 5, the tilting of the shaft 206 can result in the shaft 206 and/or the flange 212 (tilting with the shaft 206) being pressed or urged against the shock absorbing bodies 204, 208 within the anchor 102. In this example, the shaft 206 may be made of a material that is harder (e.g., more stiff, less compressible or deformable, etc.) than the elongate shock absorbing bodies 202. For example, the shaft 206 may be a steel shaft that can tilt, causing deformation of the elongate shock absorbing bodies 202, in response to force.

Similar to the example elongate shock absorbing bodies 202, the shock absorbing bodies 204, 208 may be made from a compressible material (e.g., natural rubber, polyurethane, polyethylene foam, closed cell foams, etc.) that can deform under force. In some examples, the upper and lower shock absorbing bodies 204, 208 are made of the same material as the elongate shock absorbing bodies 202. In other examples, the upper and lower shock absorbing bodies 204, 208 are made of a different material from the elongate shock absorbing bodies 202. That is, in some examples, the upper and lower shock absorbing bodies 204, 208 are stiffer than the elongate shock absorbing bodies 202. In other examples, the elongate shock absorbing bodies 202 are stiffer than the upper and lower shock absorbing bodies 204, 208. In some examples, the upper shock absorbing body 204 is made of a different material (e.g., has a different stiffness) from the lower shock absorbing body 208. Generally speaking, the example shock absorbing bodies 204, 208 are resiliently compressible or deformable but firm to support (e.g., hold, stabilize) the shaft 206 prior to and/or during impact. For example, at least the lower shock absorbing body 208 can compress when the bollard 100 is assembled such that the lower shock absorbing body 208 supports the weight of shaft 206. The example lower shock absorbing body 208 may extend beyond the first end 304 prior to assembly. Then, when the shaft 206 and the lower shock absorbing body 208 are assembled within the anchor 102, and the anchor 102 is secured to the ground 106, the lower shock absorbing body 208 is compressed (e.g., squeezed) between the flange 212 and the ground 106. The example lower shock absorbing body 208 can maintain clearance (e.g., space, gap, etc.) between the first end 304 and the ground 106. Additionally or alternatively, the example lower shock absorbing body 208 can maintain clearance between the flange 212 and the ground 106 prior to and/or during operation. Further, the example upper shock absorbing body 204 may be compressed when the anchor 102 is secured to the ground 106. As such, the example upper shock absorbing body 204 may be compressed between the anchor 102 and the flange 212.

The shock absorbing bodies 204, 208 are positioned to counteract (e.g., cushion, absorb, etc.) an impact on the bollard 100. That is, as shown in FIG. 5, an example first portion 506 of the lower shock absorbing body 208 resists a generally downward motion (e.g., force) of the flange 212 as the shaft 206 tips. Accordingly, the example first portion 506 of the lower shock absorbing body 208 can prevent the flange 212 from contacting the ground 106 during operation. Further, an example first portion 508 of the upper shock absorbing body 204 resists a generally upward motion of the flange 212 as the shaft 206 tips. Accordingly, the example first portion 508 of the upper shock absorbing body 204 can prevent the flange 212 from contacting the upper surface 315 of the anchor 102 and/or the side wall 314. In some examples, an example second portion 512 of the lower shock absorbing body 208 resists a generally lateral and/or rotational motion of the first portion 300 of the shaft 206. For example, the second portion 512 of the lower shock absorbing body 208 can prevent the first portion 300 from contacting the side wall 314 of the anchor 102.

As shown in FIG. 5, a diameter of the shaft 206 is less than a diameter of the opening 316. For relatively small impacts, the clearance between the shaft 206 and the opening 316 permits the shaft 206 to tilt without necessarily contacting the anchor 102. However, for relatively large impacts, the forces involved may overcome the reactionary forces from both the elongate shock absorbing bodies 202 and the shock absorbing bodies 204, 208 within the anchor 102 as described above. In such situations, the shaft 206 will be urged even further than shown in FIG. 5 until the outer surface 214 of the shaft 206 comes into contact with the rim of the opening 316 in the anchor 102. As a result, the force of impact will transfer directly from the rigid shaft 206 to the rigid anchor 102. However, in many instances, a significant portion of the impact will have already been absorbed by the elongate shock absorbing bodies 202 and the shock absorbing bodies 204, 208, thereby reducing the likelihood of any significant damage to the bollard 100 (or the object impacting the bollard 100).

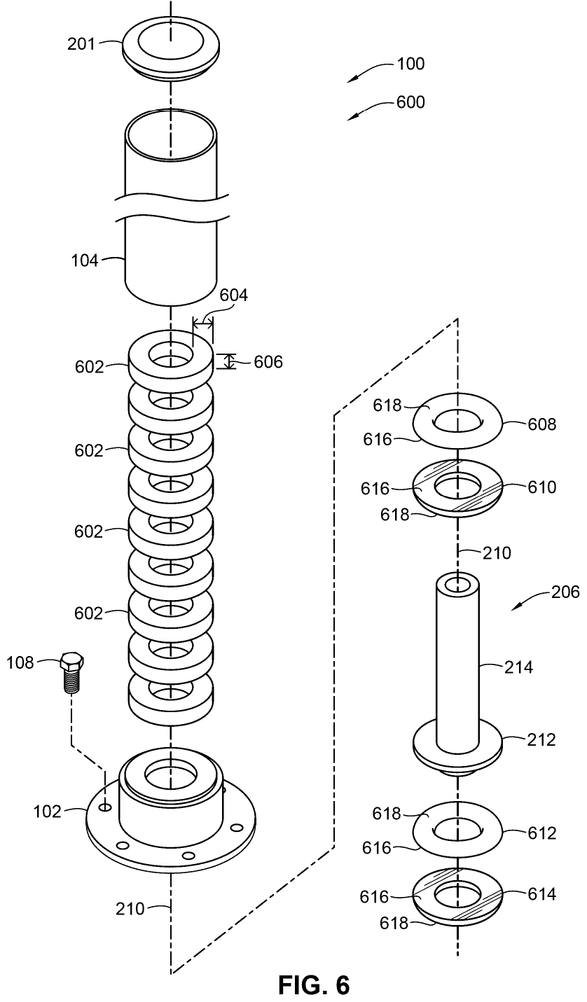

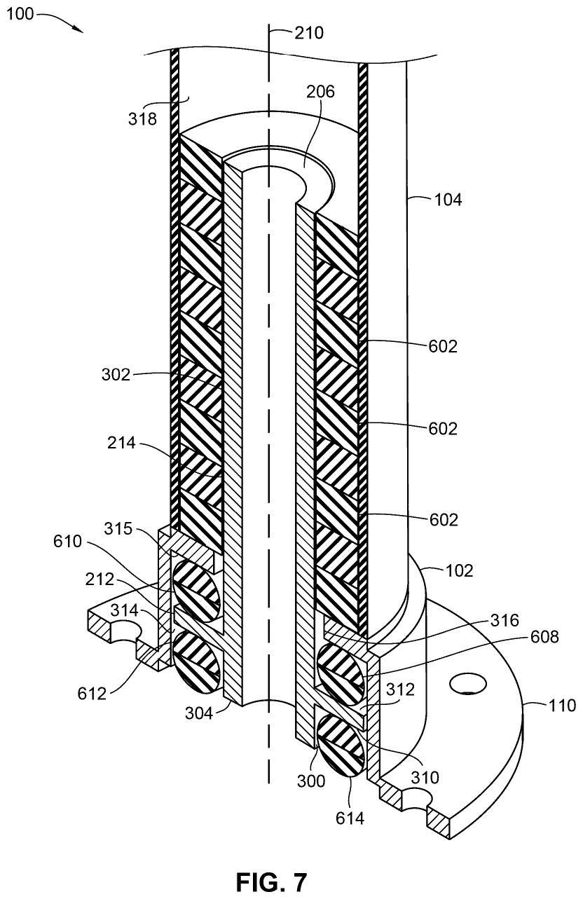

FIG. 6 is an exploded view of a second example implementation 600 of the example bollard 100 of FIG. 1. FIG. 7 is a cross-sectional view of the example bollard 100 of FIG. 6. The second example implementation 600 of FIGS. 6 and 7 is similar to the first example implementation 200 of FIGS. 2-5. The same reference numerals used in FIGS. 1-5 are used in FIGS. 6 and 7 for the same or similar components. Further, the discussion of such components provided above in connection with FIGS. 1-5 applies equally to the corresponding components shown in FIGS. 6 and 7.

The second example implementation 600 of the example bollard 100 shown in FIGS. 6 and 7 differs from the first example implementation 200 of FIGS. 2-5 in that the elongate shock absorbing bodies (e.g., pillars) 202 are omitted. Instead, in the illustrated example of FIGS. 6 and 7, a plurality of annular shock absorbing bodies 602 surround the second portion 302 of the shaft 206. In other examples, one or more of the annular shock absorbing bodies 602 can be replaced by a number of spherical or prismatic shaped bodies. Thus, the shock absorbing bodies 602 are positioned in the space between the inner surface 318 of the casing 104 and the second portion 302 of the shaft 206. Similar to the example elongate shock absorbing bodies 202 and the shock absorbing bodies 204, 208 discussed above in connection with FIGS. 2-5, the annular shock absorbing bodies 602 of FIGS. 6 and 7 may be made from a compressible material (e.g., natural rubber, polyurethane, polyethylene foam, closed cell foams, etc.) that can resiliently deform under force.

In this example, there are nine annular shock absorbing bodies 602. However, in other examples, any other number of annular shock absorbing bodies 602 may be employed. The particular number used depends on the total axial distance of the annular shock absorbing bodies 602 when stacked together and the size of each one of the annular shock absorbing bodies 602. In some examples, the annular shock absorbing bodies 602 are in the shape of a toroid with a rectangular cross-section. In other examples, the annular shock absorbing bodies 602 can have a different cross-sectional shape (e.g., circular, oval, trapezoidal, irregular, etc.). In some examples, a radial width 604 of the cross-section is greater than an axial thickness 606 of the cross-section. In some examples, the radial width 604 is equal to the axial thickness 606 (e.g., the cross-section is square). In some examples, the axial thickness 606 is greater than the radial width 604 of the cross-section. In some such examples, the axial thickness 606 can be many times greater than the radial thickness 604. That is, in some examples, the annular shock absorbing bodies 602 have a tubular shape. In some examples, a single shock absorbing body 602 with a tubular shape can be used with an axial thickness 606 (e.g., a tubular length) corresponding to the total axial distance of the stack of annular shock absorbing bodies 602 shown in FIG. 7. That is, in some examples, the bollard 100 includes only one annular shock absorbing body 602. However, in some examples, implementing multiple smaller annular shock absorbing bodies 602 can facilitate the assembly of the bollard 100. In this example, each of the annular shock absorbing bodies 602 are the same size. However, in other examples, different ones of the annular shock absorbing bodies 602 can be different sizes. In some examples, both annular and elongated shock absorbing bodies can be used (positioned within the cavity).

As shown in FIG. 7, the total axial distance of the annular shock absorbing bodies 602 when stacked together is sufficient to extend along the entire length of the second portion 302 of the shaft 206 exposed through the anchor 102. More particularly, in this example, the stack of annular shock absorbing bodies 602 extends slightly beyond the top of the shaft 206. In other examples, the stack of annular shock absorbing bodies 602 can extend farther beyond the top of the shaft 206 than what is shown in FIG. 7. In some examples, additional annular shock absorbing bodies 602 are stacked that are completely above the top of the shaft 206. That is, in some examples, the stack of annular shock absorbing bodies 602 extends beyond the top of the shaft 206 by more than the axial thickness 606 of ones of the annular shock absorbing bodies 602. In other examples, the top of the shaft 206 extends beyond the stack of annular shock absorbing bodies 602.

The second example implementation 600 of the example bollard 100 shown in FIGS. 6 and 7 also differs from the first example implementation 200 of FIGS. 2-5 in the shape of the shock absorbing bodies positioned within the anchor 102. Unlike the example shown in FIG. 205 in which a single shock absorbing body 204 is positioned above the flange 212 and a single shock absorbing body 208 is positioned below the flange 212, in the illustrated example of FIGS. 6 and 7, two shock absorbing bodies 608, 610 are positioned above the flange 212 and two shock absorbing bodies 612, 614 are positioned below the flange 212. In this example, each of the shock absorbing bodies 608, 610, 612, 614 within the anchor has a toroid shape with a semi-circular cross-section. That is, the shock absorbing bodies 608, 610, 612, 614 are bagel-shaped with flat surfaces 616 facing towards one another and rounded surfaces facing away from one another. In this example, the combined shape of the two shock absorbing bodies 608, 610 above the flange is similar to the shock absorbing body 204 shown in FIGS. 2-5. Likewise, the combined shape of the two shock absorbing bodies 612, 614 below the flange is similar to the shock absorbing body 208 shown in FIGS. 2-5. Although the sock absorbing bodies 608, 610, 612, 614 are shown and described as having a semi-circular cross-section, other shapes are possible. For instance, in some examples, the round portion of the semi-circular cross-section to define a relatively small flat annular surface opposite the larger flat surface 616 shown in the illustrated examples. In other examples, the shock absorbing bodies 608, 610, 612, 614 can have a differently shaped (e.g., trapezoidal, irregular, rectangular, etc.) cross-section. In some examples, more than two shock absorbing bodies 608, 610, 612, 614 can be positioned above and/or below the flange 212.

Although FIGS. 2-5 and FIGS. 6 and 7 are described as two separate implementations of the example bollard 100 of FIG. 1, the disclosed features in FIGS. 2-5 can be combined in any suitable manner with the disclosed features of FIGS. 6 and 7. For instance, in some examples, the annular shock absorbing bodies 602 of FIGS. 6 and 7 can be used in combination with the shock absorbing bodies 204, 208 of FIGS. 2-5. In some examples, the shock absorbing bodies 608, 610, 612, 614 can be used in combination with the elongate shock absorbing bodies 202 of FIGS. 2-5. In some examples, the annular shock absorbing bodies 602 of FIGS. 6 and 7 can be used along part of the second portion 302 of the shaft 206 with the elongate shock absorbing the example of FIGS. 2-5 used along a different part of the second portion 302 of the shaft 206. In some examples, the two shock absorbing bodies 608, 610, 612, 614 of FIGS. 6 and 7 can be used either above or below the flange 212 with one of the single shock absorbing bodies 204, 208 used on the other side of the flange 212.

In short, the foregoing examples implementations 200, 600 of the bollard 100 teach or suggest different features. Although each example implementation 200, 600 disclosed above has certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

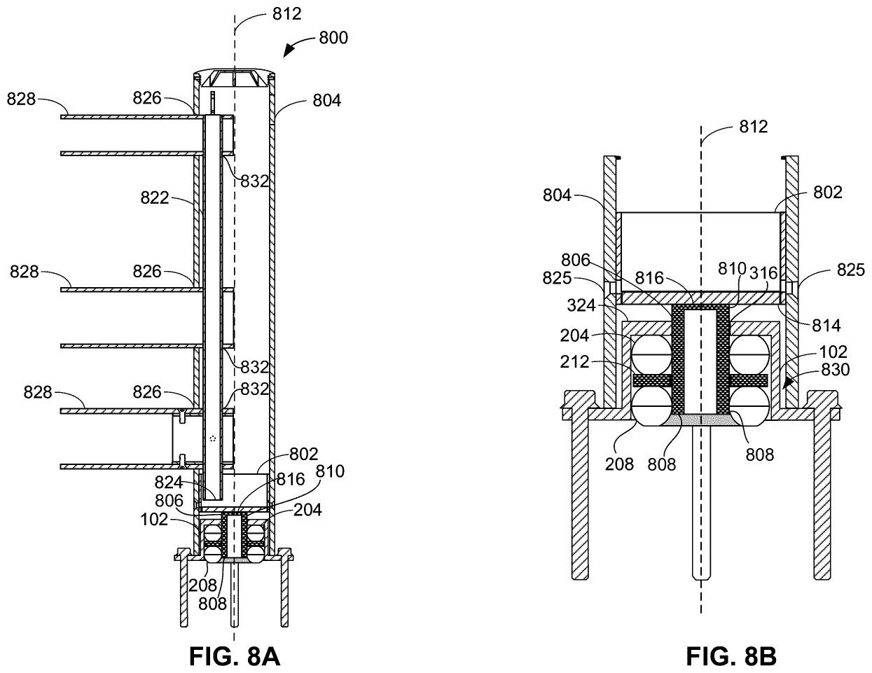

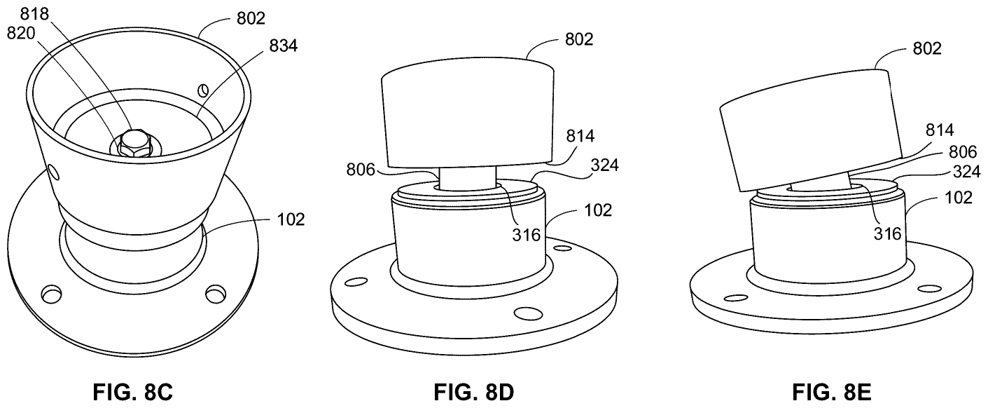

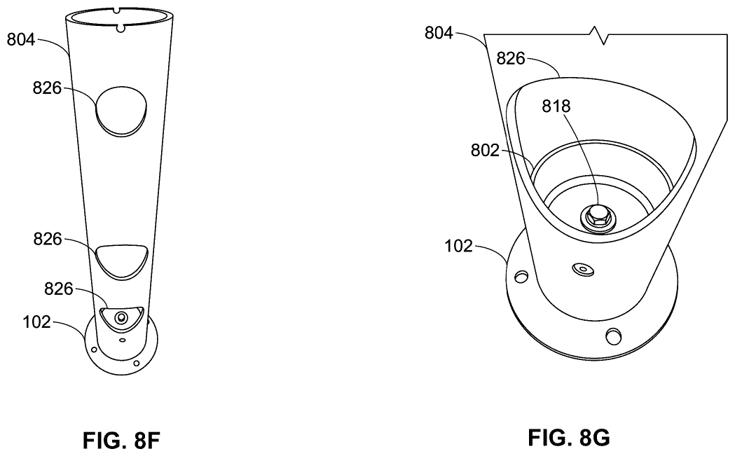

FIG. 8A is a cross-sectional view of an example first barrier 800 constructed in accordance with teachings disclosed herein. The example first barrier 800 can be implemented in an example barrier system. FIG. 8B is an enlarged view of a portion of the example first barrier 800 of FIG. 8A. FIG. 8C is a perspective view of an example cup 802 and the example anchor 102 included in the example first barrier 800 of FIGS. 8A and 8B. FIG. 8D is another perspective view of the example cup 802 and the example anchor 102. FIG. 8E is yet another perspective view of the example cup 802 and the example anchor 102. FIG. 8F is a perspective view of an example covering 804 surrounding the example cup 802 and the example anchor 102 of FIGS. 8A-8E. FIG. 8G is a detailed view of the covering 804 of FIG. 8F.

The example barrier 800 of FIGS. 8A and 8B is similar to the example bollard 100 of FIGS. 1-5 and/or 6 and 7. For example, the first barrier 800 includes the anchor 102, the flange 212, and the first and second shock absorbing bodies 204, 208 in contact with the flange 212. Alternatively, the first barrier 800 can include the shock absorbing bodies 608, 610, 612, 614 of FIGS. 6 and 7. Thus, the description of these components, detailed in connection with FIGS. 1-7 above, applies equally to the illustrated example of FIGS. 8A-8G. The first barrier 800 differs from the bollard 100 of FIGS. 1-7 in that the first barrier 800 includes an example shaft 806 that is different from the shaft 206. The example shaft 806 includes a first portion that extends in a first direction from the flange 212 to a first end 808 of the shaft 806 and a second portion that extends in a second direction from the flange 212 to a second end 810 of the shaft 806, the second direction different from the first direction. In particular, the second portion of the shaft 806 extends through the opening 316 in the anchor 102 (e.g., away from the anchor 102). The example second end 810 of the shaft 806 is coupled to the cup 802 (e.g., cylindrical protrusion). In the example of FIGS. 8A-8E, the cup 802 is spaced apart from the anchor 102 along a longitudinal axis 812 (e.g., center axis) of the shaft 806 (e.g., due to the shaft 806 extending therebetween and holding up the cup 802). For example, the cup 802 is spaced apart from the exterior surface 324 of the anchor 102.

The example cup 802 includes a mounting surface 814 (e.g., face, plate, etc.) facing the anchor 102 to contact the second end 810 of the shaft 806. For example, the mounting surface 814 is to couple (e.g., mount) to the second end 810 of the shaft 806. Further, the example cup 802 includes an annular (e.g., cylindrical) surface and/or an annular body defining a hollow body or cavity. The example annular surface surrounds a perimeter of the mounting surface 814. In the example of FIGS. 8A and 8B, the annular/hollow body of the cup 802 is aligned with the longitudinal axis 812 of the shaft 806. Additionally, the example mounting surface 814 is positioned between the annular surface and the anchor 102. The example cup 802 is a hollow cylindrical protrusion that is closed at a first end and open at a second end. The first end of the example cup 802 is associated with the mounting surface 814 and the second end of the cup 802 is associated with the annular surface. As such, the second end of the example cup 802 is open in a direction facing away from the shaft 806.

In FIGS. 8A-8E, the example opening 316 of the anchor 102 is larger than a diameter of the shaft 806 to permit the shaft 806 to tilt relative to the anchor 102. As shown in FIG. 8E, the example shaft 806 and the cup 802 can tilt relative to the anchor 102. Further, the example cup 802 is to be rigidly (but removably) affixed to the shaft 806 such that the cup 802 tilts relative to the anchor 102 when the shaft 806 tilts relative to the anchor 102 and vice versa (e.g., the shaft 806 tilts when the cup 802 tilts). In some examples, the second end 810 of the shaft 806 includes an example mounting surface 816 to contact the mounting surface 814 of the cup 802. As such, a coupling/mounting of the mounting surfaces 814, 816 can provide the rigid fixation between the cup 802 and the shaft 806.

As shown in FIGS. 8C, 8F, and 8G, the mounting surfaces 814, 816 can be coupled via an example fastener 818. For example, the fastener 818 extends through the mounting surfaces 814, 816 to couple the shaft 806 to the cup 802. In some examples, the cup 802 includes an opening 820 on the mounting surface 814 that is fitted to receive the second end 810 of the shaft 806. For example, if the second end 810 of the shaft 806 is threaded, then the opening 820 in the mounting surface 814 can be threaded to couple to the threaded end of the shaft 806 to provide the rigid fixation between the cup 802 and the shaft 806.

Additionally, the example first barrier 800 includes the covering 804 (e.g., post casing, tubular shell, etc.) (FIGS. 8A, 8B, 8F, 8G) and an example rod 822 (FIGS. 8A and 8B) that extend along the longitudinal axis 812. The example rod 822 includes a first portion having an end 824 positioned in (e.g., disposed within) the cup 802. Further, the example rod 822 includes a second portion that extends away from the cup 802 and the shaft 806. The example covering 804 of FIGS. 8A and 8B is similar to the casing 104 of FIGS. 1-7 and the detailed description provided above applies similarly to this example. For example, the covering 804 encloses the second portion of the shaft 806 (e.g., including the second end 810). However, the example covering 804 is different from the casing 104 in that the covering 804 surrounds the cup 802 and the rod 822. Thus, the example rod 822 extends along an interior of the covering 804. Further, the example cup 802 is coupled to the covering 804 via fasteners that extend through example through holes 825 (e.g., extending through sides of the first barrier 800) Further, the example covering 804 includes example openings 826 to enable example rails 828 to extend therethrough. Further still, the example covering 804 surrounds, but is spaced apart from (in a radial direction away from the axis 812), the anchor 102 to define an example gap 830. Accordingly, in this example, the outer diameter of the example anchor 102 is less than the inner diameter of the covering 804. In this example, the covering 804 is composed of High Density Polyethylene (HDPE). In other examples, the covering 804 can be composed of any suitable material (e.g., plastic, metal, another polymer, etc.) or combination thereof.

The example rails 828 couple to the second portion of the rod 822 within the covering 804. The example rails 828 extend laterally away from/to the rod 822. In some examples, the rails 828 extend laterally away from the rod 822 in a direction different from the longitudinal axis 812 of the rod 822 and the shaft 806. For example, the rails 828 extend in a direction approximately perpendicular (e.g., within 5 degrees) to the rod 822. The example rails 828 include holes 832 (e.g., cavities) that extend through each of the respective rails 828. The example rod 822 extends and/or is otherwise routed through the holes 832. As such, the example holes 832 are aligned (e.g., concentric) with one another to enable the rod 822 to extend therethrough. In FIGS. 8A and 8B, the holes 832 are circular and generally have the same cross-sectional shape as the rod 822. In other examples, the holes 832 can be slots (elongate in a direction of a main axis of the rails 828) to enable the movement of the rod 822 laterally (e.g., in the direction of the main axis of the rails 828) relative to the rails 828. Although the example rod 822 in FIGS. 8A and 8B is a tube, the rod 822 can be solid and/or any other suitable shape (e.g., ovoid, polygonal, flat, etc.). In this example, the rod 822 is composed of a rigid material (e.g., steel). In other examples, the rod 822 can be composed of any suitable material (e.g., plastic, metal, polymer, etc.) or combination thereof.

In the illustrated example of FIGS. 8A and 8B, the covering 804 is not fixed or coupled (e.g., not via fasteners, chemical adhesives, press fits, etc.) to the rod 822 or the rails 828 such that the rod 822 and the rails 828 are free to move relative to the covering 804. However, due to the interlocking relationship of the different components, such movement is relatively constrained without disassembling the first barrier 800. The example rod 822 is a structural element that transfers force in shear from the rails 828 to the cup 802 (and the rigidly coupled shaft 806), and then to the shock absorbing bodies 204, 208, which then transfer the force to the anchor 102. In some examples, the rod 822 rests on an example inner surface 834 (facing away from the mounting surface 814) of the cup 802 without being directly attached to the inner surface 834. In other words, the example rod 822 is freestanding on the cup 802). In this manner, the example rod 822 is able to move relative to the cup 802 and the anchor 102 when, for example, the first barrier 800 is subject to an impact. However, as the rod 822 moves in response to an impact, the rod 822 may come into contact with the cup 802 thereby preventing significant movement of the rod 822, which in turn provides stability for the first barrier 800. In this example, the cup 802 is composed of a rigid material (e.g., steel). In other examples, the cup 802 can be composed of any suitable material (e.g., plastic, metal, polymer, etc.) or combination thereof. Further, the example first barrier 800 is provided additional stability by the interaction between the flange 212, the shock absorbing bodies 204, 208, the anchor 102, etc., as described in connection with at least FIGS. 1-5. Further detail regarding an example implementation of the connections between the rod 822, the rails 828, and the covering 804 is provided in U.S. patent application Ser. No. 17/984,952, which is hereby incorporated herein in its entirety.

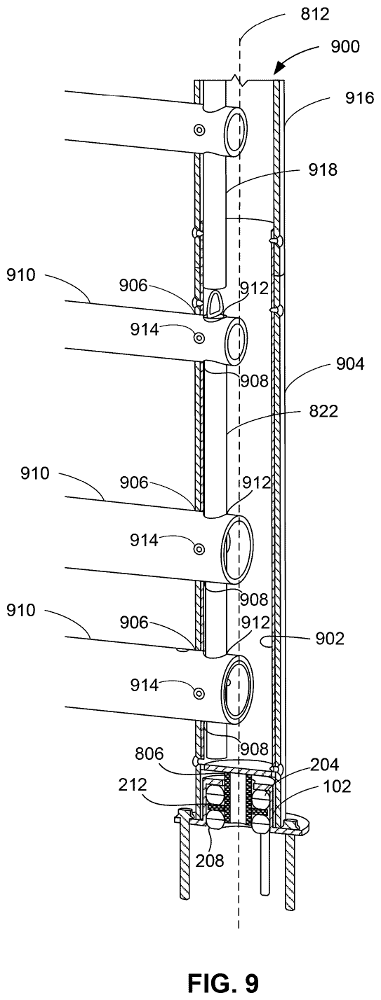

FIG. 9 is a cross-sectional view of an example second barrier 900 constructed in accordance with teachings disclosed herein. The example second barrier 900 can be implemented in an example barrier system. The example second barrier 900 of FIG. 9 is similar to the example first barrier 800 of FIGS. 8A and 8B. Thus, the same reference numbers will be used in FIG. 9 for the same or similar features shown in the earlier drawings and the associated description of those features can apply similarly to the illustrated example of FIG. 9. For example, the second barrier 900 includes the anchor 102, the first and second shock absorbing bodies 204, 208, the shaft 806, the flange 212, and the rod 822. However, the example second barrier 900 includes an example cup 902 and an example first covering 904 of FIG. 9 that are different in size, shape, and/or proportion than the example cup 802 and the example covering 804 of FIG. 8A. For example, the cup 902 includes a height (e.g., length) that is significantly greater than a width (e.g., diameter) of the cup 902 (e.g., the height to width ratio can be 3, 4, 5, 6, 7, 10, etc.). In some examples, the height of the cup is defined to extend up to a point below which a majority of impacts with the post are expected (e.g., the top of the cup reaches up to 2 feet, up to 2.5 feet, up to 3 feet, up to 3.5 feet, up to 4 feet, up to 4.5 feet, up to 5 feet, etc.). Additionally or alternatively, the height of the example cup 902 is defined to extend along a length of the rod 822 and/or the first covering 904. In some examples, the height of the cup 902 (along the longitudinal axis 812) is greater than a length of the rod 822. Similar to the cup 802 of FIGS. 8A, 8B 8C, 8D, 8E, 8F, 8G, the example cup 902 of FIG. 9 is spaced apart from the anchor 102 along the longitudinal axis 812 of the shaft 806. In the example first barrier 800 or the example second barrier 900, an additional shock absorbing body may be positioned in the space between the cup (e.g., the cup 802 or the cup 902) and the anchor 102. For example, an additional shock absorbing ring surrounds the second portion of the shaft 806 in the space between the cup 802 and the anchor 102 and/or the cup 902 and the anchor 102.

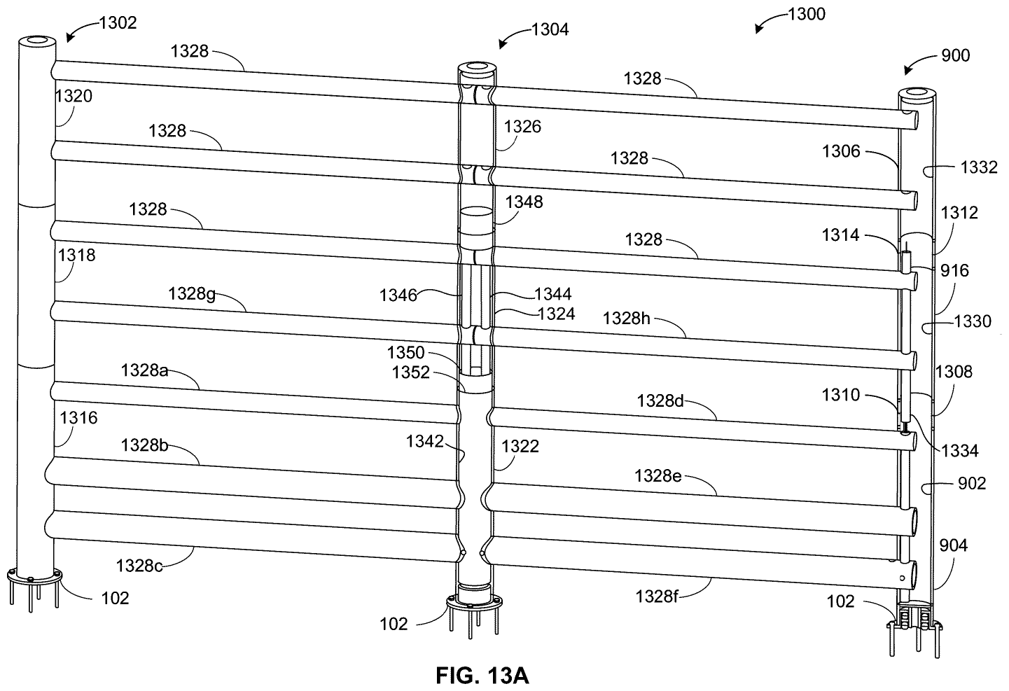

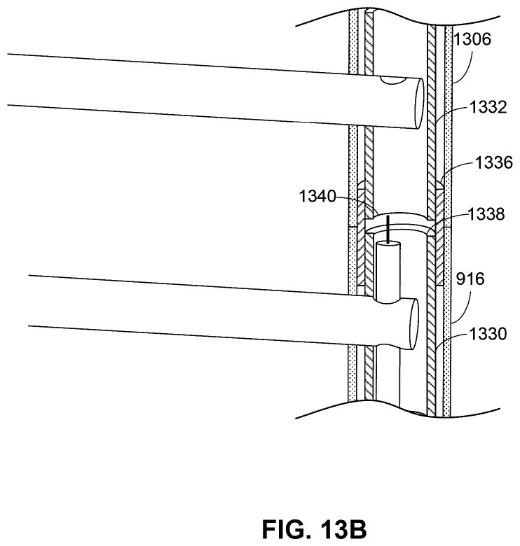

The example second barrier 900 includes an example first covering 904 that surrounds the rod 822 and the cup 902. The example first covering 904 includes example openings 906 aligned to (e.g., concentric with) example openings 908 in the cup 902 to enable example rails 910 to extend therethrough. Similar to the rails 828 of FIG. 8A, the example rails 910 of FIG. 9 include holes 912 fitted to receive the rod 822. Further, the example rails 910 extend laterally away from the rod 822, the cup 902, and the first covering 904. However, the example rails 910 include holes 914 to provide additional points to maintain the rails 910 coupled to the rod 822. In some examples, this coupling is achieved by threaded fasteners extending through the holes 914 and corresponding holes in the rod 822. In some examples, the holes 914 are the only holes through which fasteners are placed to secure the rails 910 to the rod 822. Further, the particular position of the holes 914 are for purposes of explanation. In other examples, a different number of holes and/or different placements of the holes may be used. Further, in some examples, the same arrangement of the holes and fasteners are used for each of the rails 910 to secure each to the corresponding rod 822. However, in other examples, different ones of the rails 910 (and associated rods) may include different numbers of holes (and associated fasteners) and/or the holes (and associated fasteners) may be in different locations relative to the other rails. Further, the example second barrier 900 includes an example second covering 916 surrounding another example rod 918, as described in detail in connection with FIGS. 13A and 13B.

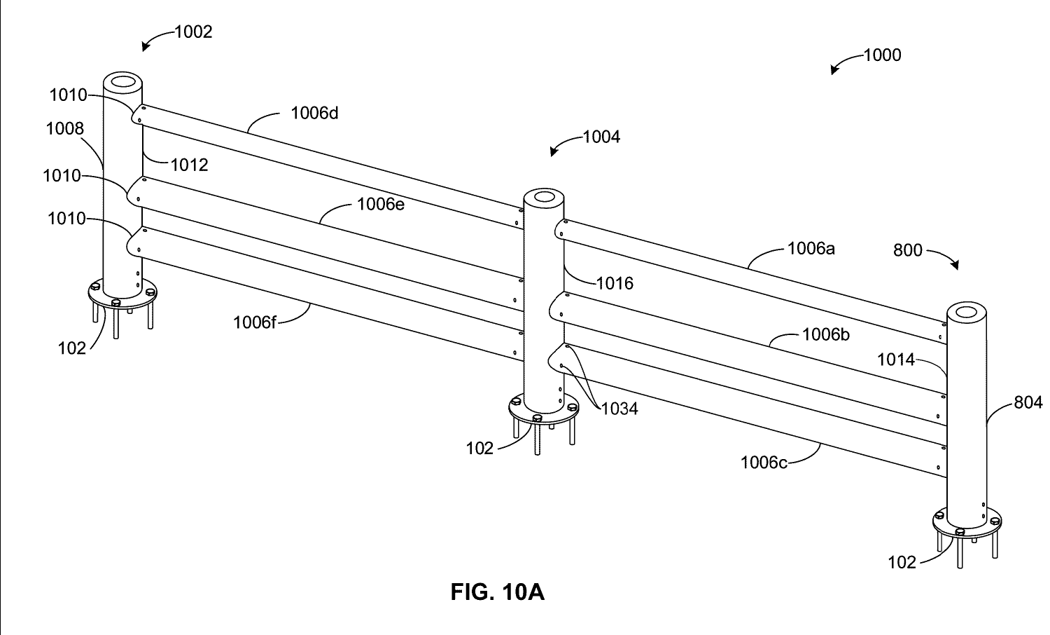

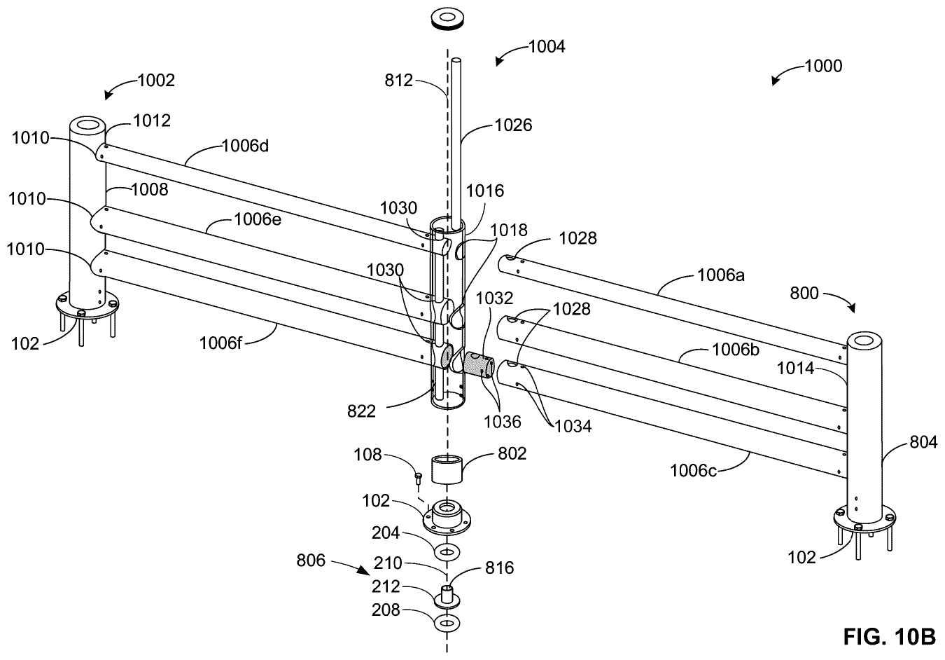

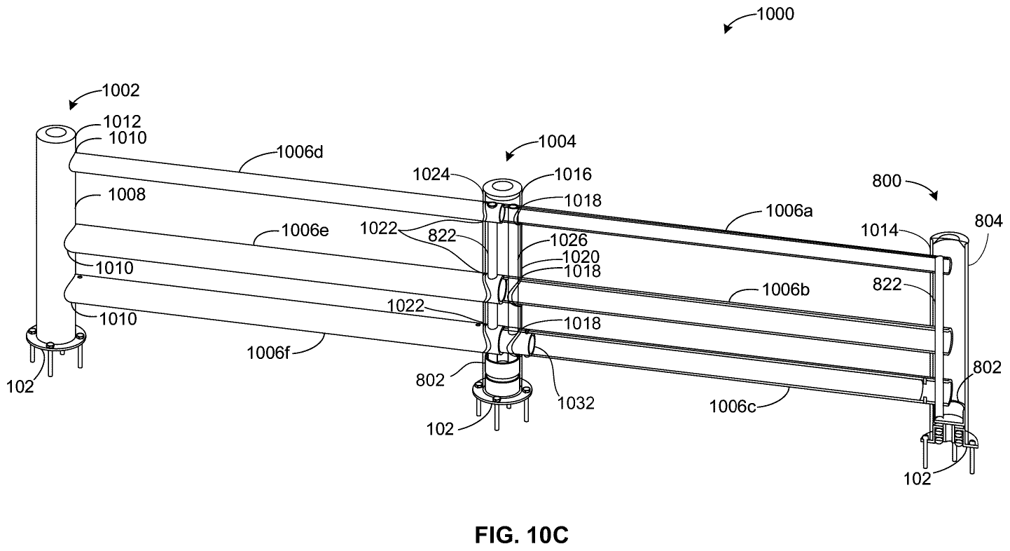

FIG. 10A is a perspective view of an example first barrier system 1000 constructed in accordance with teachings disclosed herein. The example first barrier system 1000 includes the example first barrier 800 of FIG. 8A, an example third barrier 1002, and an example fourth barrier 1004. FIG. 10B is an exploded view of a portion of the example first barrier system 1000 of FIG. 10A. In particular, FIG. 10B is an exploded view of the fourth barrier 1004 of FIG. 10A. FIG. 10C is a detailed view of the example first barrier system 1000 of FIGS. 10A and 10B. In the illustrated example of FIG. 10C, the exterior of the fourth barrier 1004 is see-through for purposes of illustration to enable the interior components to be visible. Likewise, in FIG. 10C, a cross-sectional view of the example first barrier 800 is shown to enable the interior components to be visible. The example first barrier system 1000 of FIGS. 10A-10C is configured to withstand impacts from vehicles (e.g., fork trucks) and other heavy equipment. The example barriers 800, 1002, 1004 are vertically oriented structural elements that anchor the first barrier system 1000 to the ground or floor. For example, one or more fasteners (e.g., the screws 108) mount the barriers 800, 1002, 1004 to the ground or floor. In some examples, impacts to example rails 1006a-1006f are transferred to the barriers 800, 1002, 1004 to protect people and/or objects on the other side of the first barrier system 1000. While the example first barrier system 1000 is depicted with the three barriers 800, 1002, 1004 and the six example rails 1006a-1006f, the first barrier system 1000 can have any suitable number of barriers and/or rails. In other examples, the path of the first barrier system 1000 may include corners and/or otherwise follow a non-straight line. Further, the example second barrier 900 can be used to implement any of the example barriers 800, 1002, 1004.

The example rails 1006a-1006f are horizontally oriented structural elements that transfer shear (or transverse) impacts to the first barrier system 1000 to the ground via the barriers 800, 1002, 1004. In the illustrated example of FIGS. 10A-10C, the rails 1006a-1006f are hollow tubular elements. In other examples, the rails 1006a-1006f can be solid elements and/or have any other suitable shape. In some examples, the rails 1006a-1006f can be composed of High Density Polyethylene (HDPE). In other examples, the rails 1006a-1006f can be composed of any other suitable materials (e.g., another plastic, another polymer, a metal, etc.). In the illustrated example of FIGS. 10A-10C, the rails 1006a-1006f extend between adjacent ones of the barriers 800, 1002, 1004. In some examples, the rails 1006a-1006f can be composed of a unitary structural element that extends all the way through one or more of the barriers 800, 1002, 1004.

The example third barrier 1002 of FIGS. 10A-10C is similar to the example first barrier 800 of FIGS. 8A and 8B. Thus, the same reference numbers will be used in FIGS. 10A-10C for the same or similar features shown in the earlier drawings and the associated description of those features can apply similarly to the illustrated example of FIGS. 10A-10C. For example, the third barrier 1002 includes the anchor 102, the shaft 806, the flange 212, the shock absorbing bodies 204, 208, the rod 822, and the cup 802 (some of which are not shown in FIGS. 10A-10C for purposes of explanation). Further, the example third barrier 1002 includes an example covering 1008 having openings 1010 to receive example rails 1006d, 1006e, 1006f. However, the openings 1010 in the covering 1008 are positioned on a side 1012 of the third barrier 1002 different from a side 1014 of the first barrier 800. In particular, the side 1012 of the third barrier 1002 faces and/or mirrors the side 1014 of the first barrier 800.

The example fourth barrier 1004 of FIGS. 10A-10C is similar to the example first barrier 800 of FIGS. 8A and 8B. For example, the fourth barrier 1004 includes the anchor 102, the shaft 806, the flange 212, the shock absorbing bodies 204, 208, the rod 822, the cup 802, etc. Further, the example fourth barrier 1004 includes an example covering 1016 having openings 1018 on a first side 1020 of the fourth barrier 1004 and openings 1022 on a second side 1024 of the fourth barrier 1004 opposing the first side 1020. Further, the example fourth barrier 1004 includes another example rod 1026 disposed within the cup 802 and enclosed by the covering 1016. The example rod 1026 extends through holes 1028 in the rails 1006a, 1006b, 1006c and the example rod 822 extends through holes 1030 in the rails 1006d, 1006e, 1006f. As shown in FIGS. 10B and 10C, the example fourth barrier 1004 includes an example sleeve 1032 to facilitate (e.g., strengthen, support, etc.) the connection between the covering 1016, the rail 1006c, and the rod 1026. For example, the rail 1006c includes holes 1034 that align with corresponding holes 1036 in the sleeve 1032 to receive retaining elements (e.g., threaded fasteners) that facilitate the coupling of the sleeve 1032 to the rail 1006c. In some examples, fasteners extending through the holes 1034, 1036 maintain the position of the sleeve 1032 within the rail 1006c to prevent the sleeve 1032c from moving concentrically within the rail 1006c. Likewise, fasteners prevent the sleeve 1032 from moving axially along the length of the rail 1006c. As a result, when the rail 1006c is impacted, the force of the impact will transfer to the sleeve 1032 to then be transferred to the rod 1026, to then be transferred to cup 802 (and the rigidly coupled shaft 806), to then be transferred to the shock absorbing bodies 204, 208, to then be transferred to the anchor 102. In some examples, any of the rails 1006a-1006f can likewise include example sleeves to reinforce the connection between associated coverings, rods, rails, etc.

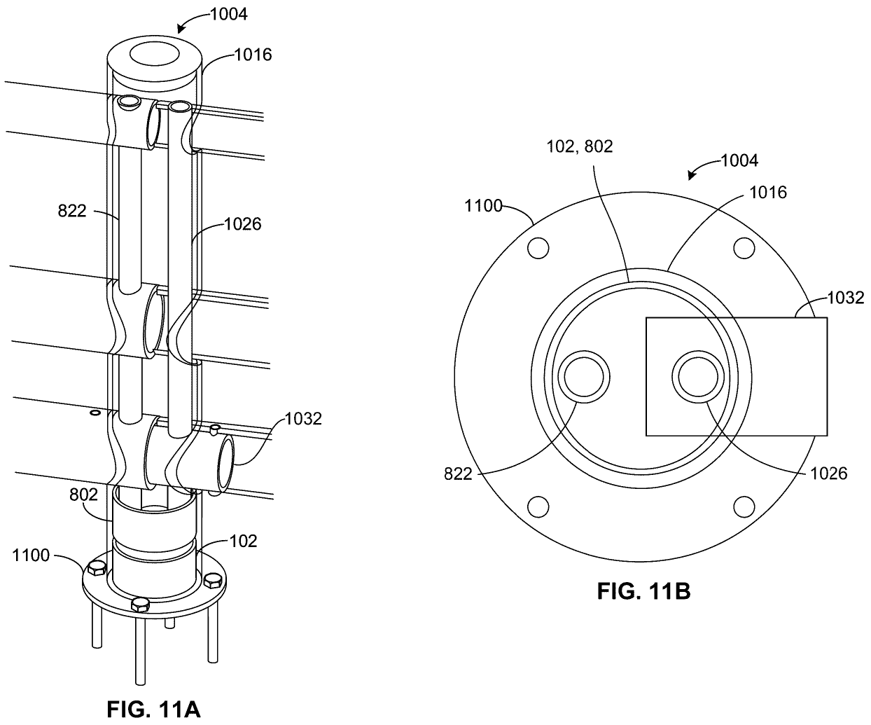

FIG. 11A is an enlarged, perspective view of the example fourth barrier 1004 of FIGS. 10A-10C. As with FIG. 10C, the exterior of the example fourth barrier 1004 in FIG. 11A is see-through or transparent for purposes of explanation. FIG. 11B is a top view of the example fourth barrier 1004 of FIG. 11A. The same reference numbers will be used in FIGS. 11A and 11B for the same or similar features shown in the earlier drawings and the associated description of those features (e.g., in FIGS. 10A-10C). As shown in FIGS. 11A and 11B, the example fourth barrier 1004 includes the anchor 102, the cup 802, the rod 822, the covering 1016, the rod 1026, and the sleeve 1032. Further, the example anchor 102 includes a diameter that is approximately the same (e.g., within 1 inch, within 0.1 inch) as a diameter of the cup 802. In some examples, the diameter of the cup 802 is less than the diameter of the anchor 102. Accordingly, the example covering 1016 can surround and/or enclose the anchor 102, the cup 802, and the shaft 806. Put differently, the covering 1016 can extend across the lengths of the cup 802 and the anchor 102 to contact a lip 1100 of the anchor 102.

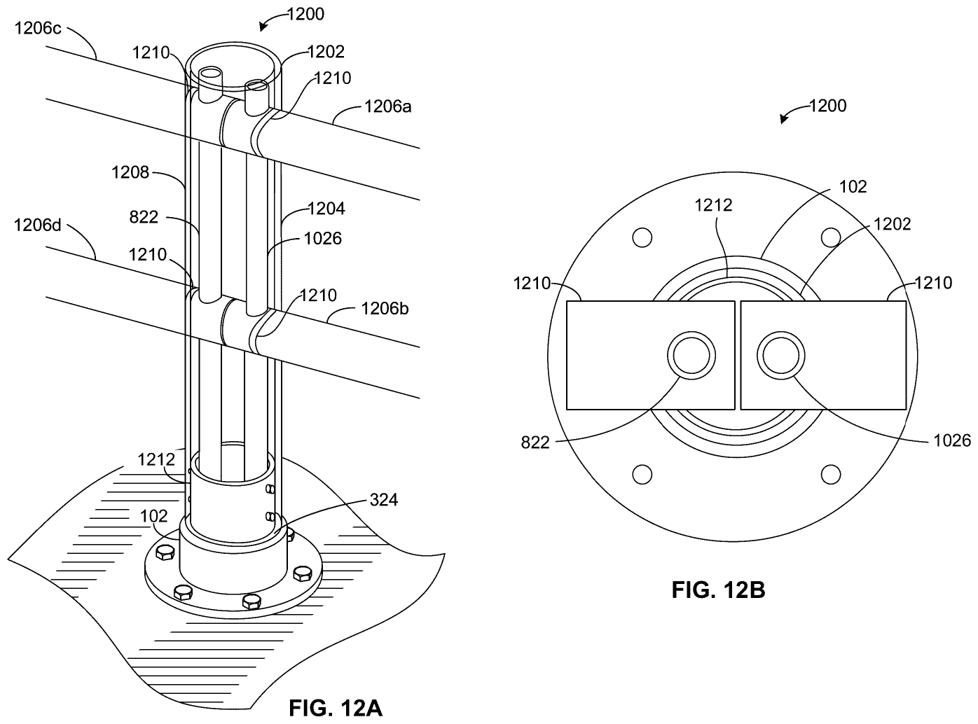

FIG. 12A is an enlarged, perspective view of an example fifth barrier 1200 constructed in accordance with teachings disclosed herein. As with FIG. 11A, the exterior of the example fifth barrier 1200 in FIG. 12A is see-through or transparent for purposes of explanation. FIG. 12B is a top view of the example fifth barrier 1200 of FIG. 12A. The example fifth barrier 1200 of FIGS. 12A and 12B is similar to the example fourth barrier 1004 of FIGS. 10A-11B. Thus, the same reference numbers will be used in FIGS. 12A and 12B for the same or similar features shown in the earlier drawings and the associated description of those features.

The example fifth barrier 1200 of FIGS. 12A and 12B includes the anchor 102, the rod 822, and the rod 1026. However, the example fifth barrier 1200 includes an example covering 1202 having two openings on a first side 1204 to receive example rails 1206a, 1206b and two openings on a second side 1208 of the fifth barrier 1200 to receive example rails 1206c, 1206d. Further, the example fifth barrier 1200 includes example sleeves 1210 to support the connection between the rails 1206a-1206d and rods 822, 1026. Additionally, the example fifth barrier 1200 includes an example cup 1212 that is smaller in diameter than the anchor 102 (e.g., the inner diameter of the cup 1212 is smaller than the outer diameter of the anchor 102). As such, the example covering 1202 surrounds the cup 1212 (e.g., the covering 1202 is to be in contact with an outer diameter of the cup 1212). Further, the example covering 1202 extends from the exterior surface 324 of the anchor 102 towards the proximate ends of the rods 822, 1026. As such, the covering 1202 does not surround a body of the anchor 102.

FIG. 13A is a perspective view of an example second barrier system 1300 constructed in accordance with teachings disclosed herein. FIG. 13A includes the example second barrier 900 of FIG. 9, an example sixth barrier 1302, and an example seventh barrier 1304. In the illustrated example of FIG. 13A, the exterior of the seventh barrier 1304 is see-through for purposes of illustration to enable the interior components to be visible. Likewise, in FIG. 13A, a cross-sectional view of the example second barrier 900 is shown to enable the interior components to be visible. FIG. 13B is an enlarged view of a portion of the example second barrier system 1300 of FIG. 13A.

The example second barrier system 1300 of FIGS. 13A and 13B is similar to the example first barrier system 1000 of FIGS. 10A-10C. However, the example second barrier system 1300 includes a stacked configuration of example coverings. For example, the second barrier 900 includes the first covering 904, the example second covering 916 adjacent to the first covering 904, and an example third covering 1306 adjacent to the second covering 916. Further, the example second covering 916 and the example third covering 1306 are aligned to a longitudinal axis (e.g., the longitudinal axis 812 of FIGS. 8A, 8B, and 9) of the first covering 904. In the example of FIGS. 13A and 13B, an end 1308 of the first covering 904 contacts an end 1310 of the second covering 916. Further, an example end 1312 of the second covering 916 contacts an end 1314 of the third covering 1306. As such, the first, second, and third coverings 904, 916, 1306 define the stacked configuration of the second barrier 900. Similarly, the example sixth barrier 1302 includes example coverings 1316, 1318, 1320 to define a stacked configuration, and the example seventh barrier 1304 includes example coverings 1322, 1324, 1326 to define a stacked configuration. In some examples, the second barrier system 1300 can extend up to any suitable height (e.g., at least 6 feet, at least 8 feet, at least 10 feet, at least 12 feet, at least 20 feet, etc.). Further, akin to the first barrier system 1000 of FIGS. 10A-10C, the example second barrier system 1300 includes example rails 1328 that extend between adjacent ones of the barriers 900, 1302, 1304.

The example second and third coverings 916, 1306 can surround and/or enclose example tubes 1330, 1332 respectively. In some examples, the tubes 1330, 1332 are more rigid than the second and third coverings 916, 1306 to provide additional support for the relatively tall height of the barriers 900, 1302, 1304. For instance, in some examples, the coverings 916, 1306 are composed of a polymer and the tubes 1330, 1332 are composed of metal. In this example, the tubes 1330, 1332 are composed of a rigid material (e.g., steel). In other examples, the tubes 1330, 1332 can be composed of any suitable material (e.g., plastic, metal, polymer, etc.) or combination thereof. The example tube 1330 surrounds and/or encloses an example rod 1334 associated with the second covering 916. As such, the example tube 1330 extends along a length of the second covering 916. In the example of FIGS. 13A and 13B, the third covering 1306 does not surround any example rod. However, an additional example rod can extend along the interior of the third covering 1306 and the tube 1332.

The example second barrier system 1300 includes example sleeves that connect adjacent ones of the example tubes 1330, 1332, adjacent ones of the coverings (e.g., the first covering 904 and the second covering 916, the covering 1324 and the covering 1326, etc.), adjacent pairs of a cup and a covering (e.g., an example cup 1342 and the covering 1324), or any combination of tubes, coverings, cups, etc. For example, turning to FIG. 13B, the example second barrier 900 includes an example sleeve 1336 that supports a connection between the tube 1330 and the tube 1332. For example, the sleeve 1336 surrounds an end 1338 of the tube 1330 and an end 1340 of the tube 1332. In other examples, the sleeve 1336 can fit inside the ends of adjacent tubes 1330, 1332 rather than around the outside of the tubes 1330, 1332. Similarly, another example sleeve can surround (or fit inside) the cup 902 and the end of the tube 1330 (opposing the end 1338). In other words, in some examples, the annular portion of the cup 902 effectively corresponds to a lowermost tube in the barrier that is coupled with other tubes on top and connected together at the seams by associated sleeves.

The example sixth and seventh barriers 1302, 1304 can likewise include example tubes, rods, cups, sleeves, etc., akin to the second barrier 900. For example, the example rails 1328a-1328f (e.g., the lower six rails) extend through example cups (e.g., the cup 902 of the second barrier 900, the cup 1342 of the seventh barrier 1304, etc.) that extend along lengths of each of the example coverings 904, 1316, 1322, etc. The example seventh barrier 1304 of FIG. 13A is similar to the example fourth barrier 1004 of FIGS. 10A-10C. For example, the covering 1322 associated with the seventh barrier 1304 surrounds two example rods (hidden by the cup 1342 in FIG. 13A for purposes of explanation) disposed within the cup 1342. However, the covering 1324 associated with the seventh barrier 1304 is stacked/positioned on the covering 1322 to surround two example rods 1344, 1346. In turn, each of the example rods 1344, 1346 extend through at least the rails 1328g, 1328h.

The example seventh barrier 1304 includes an example sleeve 1348. The example sleeve 1348 is similar to the example sleeve 1336 of FIG. 13B. However, the example sleeve 1348 supports a connection between the covering 1324 and the covering 1326 (e.g., without any tubes). For example, the sleeve 1348 is positioned within the coverings 1324, 1326. Further, the example sleeve 1348 extends across an end of the covering 1324 and an end of the covering 1326. As such, the coverings 1324, 1326 are connected together at the seams/ends by the associated sleeve 1348. In some examples, fasteners extend through the coverings 1324, 1326 and the sleeve 1348 to reinforce the connection.

Similarly, a topmost portion of the example cup 1342 in the seventh barrier 1304 can function as a sleeve to support a connection between the covering 1322 and the covering 1324. For example, an end 1350 of the cup 1342 extends across (e.g., above) an example interface 1352 between an end of the covering 1322 and an end of the covering 1324. As such, at least some of the cup 1342 can surround interiors of the coverings 1322, 1324 to connect the coverings 1322, 1324. In some examples, fasteners can extend through the coverings 1322, 1324 and the topmost portion of the cup 1342 to reinforce the connection.

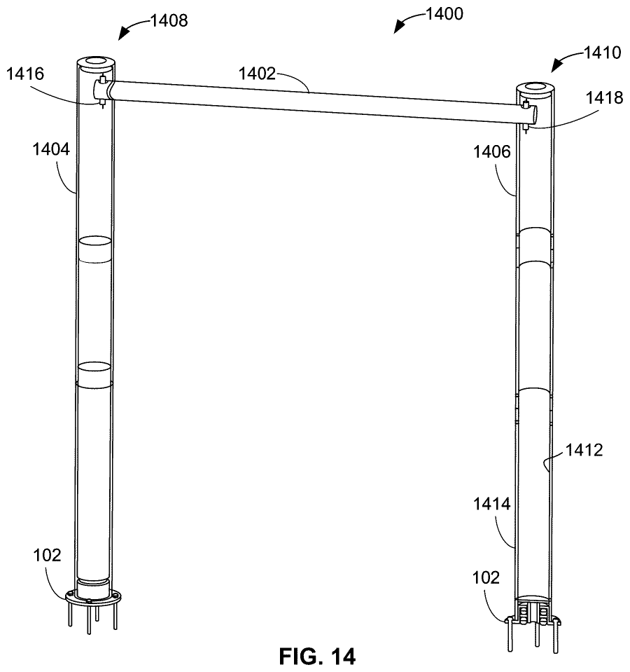

FIG. 14 is a perspective view of an example third barrier system 1400 constructed in accordance with teachings disclosed herein. The example third barrier system 1400 of FIG. 14 is similar to the example second barrier system 1300 of FIGS. 13A and 13B. However, the example third barrier system 1400 includes one rail 1402 extending through/between example coverings 1404, 1406 (e.g., instead of the series of rails 1328 throughout the height of the second barrier system 1300 of FIGS. 13A and 13B). Further, the example third barrier system 1400 includes two example barriers (e.g., an example eighth barrier 1408 and an example ninth barrier 1410) (e.g., instead of the three barriers 900, 1302, 1304 in the second barrier system 1300). Similar to the example of FIG. 13A, the eighth barrier 1408 is see-through or transparent for purposes of explanation, and the ninth barrier 1410 is shown in a cross-sectional view for purposes of explanation. The example ninth barrier 1410 of FIG. 14 is similar to the example second barrier 900 of FIG. 9. However, the example ninth barrier 1410 of FIG. 14 does not include example openings in an example cup 1412 or an example covering 1414. In other words, the example covering 1414 and the cup 1412 include smooth, continuous surfaces that extend along a length of the ninth barrier 1410. For example, the covering 1414 and/or the cup 1412 can extend a full length of the ninth barrier 1410 (e.g., from the anchor 102 to the rail 1402). As such, the example coverings 1404, 1406 may be excluded from the third barrier system 1400. In FIG. 14, the example third barrier system 1400 exhibits a stacked configuration, with only the proximal coverings 1404, 1406 (e.g., the coverings positioned farthest from the anchors 102) having example openings fitted to receive the rail 1402. Further, the example rail 1402 includes holes fitted to receive example rods 1416, 1418 (e.g., pins) enclosed within the example coverings 1404, 1406, respectively. The example rods 1416, 1418 of FIG. 14 are similar to other example rods disclosed herein. However, the example rods 1416, 1418 are shorter in height than, for example, the rod 822 of at least FIG. 8A.

From the foregoing, it will be appreciated that example systems, apparatus, articles of manufacture, and methods have been disclosed that utilize shock absorbing material to resist impacts experienced by example bollards and associated barrier systems. Examples disclosed herein reduce the risk of damage to barrier systems by employing shock absorbing material that can contact a shaft within the barrier and/or an anchor of the barrier. Examples disclosed herein utilize a shaft flange to distribute forces to other load bearing portions of the barrier. Examples disclosed herein include rods that can move relative to cups, anchors, etc., when example barriers disclosed herein are subject to an impact. For example, as an example rod disclosed herein moves in response to an impact, the rod may come into contact with the cup, which then transfers the impact force (via the shaft attached to the bottom side of the cup) to shock absorbing bodies within the anchor that absorb more of the impact force, thereby preventing significant movement of the rod, which in turn provides stability for an example barrier and reduces stress and/or failure of the components of the example barrier.

Further examples and combinations thereof include the following:

Example 1 includes a barrier system comprising a shaft having a first end and a second end opposite the first end, an anchor to be positioned at the first end of the shaft, the anchor having an opening, the second end of the shaft to extend through the opening, the second end of the shaft to extend away from the anchor, a cup coupled to the second end of the shaft, the cup spaced apart from the anchor along a longitudinal axis of the shaft, and a shock absorbing body to engage with the shaft, the shock absorbing body enclosed by the anchor.

Example 2 includes the barrier system of example 1, wherein the cup includes a mounting surface facing the anchor, the mounting surface to couple to the second end of the shaft, and an annular surface defining a hollow body, the annular surface to surround a perimeter of the mounting surface, the mounting surface positioned between the annular surface and the anchor.

Example 3 includes the barrier system of example 2, wherein the mounting surface is a first mounting surface, the second end of the shaft includes a second mounting surface, and the second mounting surface is to contact the first mounting surface.

Example 4 includes the barrier system of example 1, wherein the shaft includes a flange positioned on an outer surface of the shaft, the flange extending away from the outer surface, a first portion of the shaft extending in a first direction away from the flange and a second portion of the shaft extending in a second direction away from the shaft, the second direction different from the first direction.

Example 5 includes the barrier system of example 4, wherein the shock absorbing body is to be positioned between a first face of the flange and a ground surface on which the barrier is to be mounted, the shock absorbing body to contact at least a portion of the first portion of the shaft.

Example 6 includes the barrier system of example 5, wherein the shock absorbing body is a first shock absorbing body, further including a second shock absorbing body to be positioned between a second face of the flange and a surface of the anchor, the second face of the flange opposite the first face.

Example 7 includes the barrier system of example 1, further including a rod, a first portion of the rod positioned in the cup and a second portion of the rod extending away from the cup and the shaft, a post casing to enclose the cup, the shaft, and the rod, and a rail to extend through an opening in the post casing, the rail to be coupled to the second portion of the rod within the post casing.

Example 8 includes the barrier system of example 7, wherein the rod extends in a first direction aligned to a longitudinal axis of the post casing.

Example 9 includes the barrier system of example 8, wherein the rail extends in a second direction different from the first direction.

Example 10 includes an apparatus comprising a shaft, a shock absorbing body to engage with a first portion of the shaft, a housing to enclose the first portion of the shaft and the shock absorbing body, and a hollow cylindrical protrusion being closed at a first end and open at a second end, the first end to be coupled to the shaft, the second end to open in a direction facing away from the shaft.

Example 11 includes the apparatus of example 10, further including a covering to enclose the shaft, the housing, and the cylindrical protrusion.

Example 12 includes the apparatus of example 11, further including a rod to extend along an interior of the covering, an end of the rod to be disposed within the cylindrical protrusion.

Example 13 includes the apparatus of example 12, wherein the rod is a first rod and the covering is a first covering, further including a second covering positioned adjacent to the first covering, the second covering aligned to a longitudinal axis of the first covering, and a second rod to extend along an interior of the second covering, an end of the second covering to contact an end of the first covering.

Example 14 includes the apparatus of example 13, wherein the cylindrical protrusion extends along a length of the first covering, further including a tube to surround the second rod, the tube to extend along a length of the second covering, the second covering to surround the tube.

Example 15 includes the apparatus of example 14, further including a sleeve to connect the second end of the cylindrical protrusion to an end of the tube, the end of the tube adjacent to the end of the second covering.

Example 16 includes the apparatus of example 13, further including a first rail to extend laterally away from the second rod, the first rail extending through a first opening in the second covering, the second rod extending through a first hole in the first rail, and a second rail to extend laterally away from the first rod, the second rail extending through a second opening in the first covering, the first rod extending through a second hole in the second rail.

Example 17 includes an apparatus comprising a shaft, a collar having a cavity to enclose a first portion of the shaft, the collar having an opening to enable a second portion of the shaft to protrude from the collar, a cup to be mounted to an end of the second portion of the shaft, a rod to be disposed within the cup, and a tubular shell to surround the cup and the rod.

Example 18 includes the apparatus of example 17, wherein the opening is larger than a diameter of the shaft to permit the shaft to tilt relative to the collar, the cup to be rigidly affixed to the shaft to tilt relative to the collar when the shaft tilts relative to the collar.

Example 19 includes the apparatus of example 17, wherein the cup includes a first diameter and the collar includes a second diameter, the second diameter less than the first diameter.

Example 20 includes the apparatus of example 19, wherein the cup has a height and a width, the height at least four times the width.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A barrier system comprising:
a shaft having a first end and a second end opposite the first end;
an anchor to be positioned at the first end of the shaft, the anchor having an opening, the second end of the shaft to extend through the opening, the second end of the shaft to extend away from the anchor;
a cup coupled to the second end of the shaft, the cup spaced apart from the anchor along a longitudinal axis of the shaft; and
a shock absorbing body to engage with the shaft, the shock absorbing body enclosed by the anchor.

2. The barrier system of claim 1, wherein the cup includes:
a mounting surface facing the anchor, the mounting surface to couple to the second end of the shaft; and
an annular surface defining a hollow body, the annular surface to surround a perimeter of the mounting surface, the mounting surface positioned between the annular surface and the anchor.

3. The barrier system of claim 2, wherein the mounting surface is a first mounting surface, the second end of the shaft includes a second mounting surface, and the second mounting surface is to contact the first mounting surface.

4. The barrier system of claim 1, wherein the shaft includes a flange positioned on an outer surface of the shaft, the flange extending away from the outer surface, a first portion of the shaft extending in a first direction away from the flange and a second portion of the shaft extending in a second direction away from the shaft, the second direction different from the first direction.

5. The barrier system of claim 4, wherein the shock absorbing body is to be positioned between a first face of the flange and a ground surface on which the barrier is to be mounted, the shock absorbing body to contact at least a portion of the first portion of the shaft.

6. The barrier system of claim 5, wherein the shock absorbing body is a first shock absorbing body, further including a second shock absorbing body to be positioned between a second face of the flange and a surface of the anchor, the second face of the flange opposite the first face.

7. The barrier system of claim 1, further including:
a rod, a first portion of the rod positioned in the cup and a second portion of the rod extending away from the cup and the shaft;
a post casing to enclose the cup, the shaft, and the rod; and
a rail to extend through an opening in the post casing, the rail to be coupled to the second portion of the rod within the post casing.

8. The barrier system of claim 7, wherein the rod extends in a first direction aligned to a longitudinal axis of the post casing.

9. The barrier system of claim 8, wherein the rail extends in a second direction different from the first direction.

10. An apparatus comprising:
a shaft;
a shock absorbing body to engage with a first portion of the shaft;
a housing to enclose the first portion of the shaft and the shock absorbing body; and
a hollow cylindrical protrusion being closed at a first end and open at a second end, the first end to be coupled to the shaft, the second end to open in a direction facing away from the shaft.

11. The apparatus of claim 10, further including a covering to enclose the shaft, the housing, and the cylindrical protrusion.

12. The apparatus of claim 11, further including a rod to extend along an interior of the covering, an end of the rod to be disposed within the cylindrical protrusion.

13. The apparatus of claim 12, wherein the rod is a first rod and the covering is a first covering, further including:
a second covering positioned adjacent to the first covering, the second covering aligned to a longitudinal axis of the first covering; and
a second rod to extend along an interior of the second covering, an end of the second covering to contact an end of the first covering.

14. The apparatus of claim 13, wherein the cylindrical protrusion extends along a length of the first covering, further including a tube to surround the second rod, the tube to extend along a length of the second covering, the second covering to surround the tube.

15. The apparatus of claim 14, further including a sleeve to connect the second end of the cylindrical protrusion to an end of the tube, the end of the tube adjacent to the end of the second covering.

16. The apparatus of claim 13, further including:
a first rail to extend laterally away from the second rod, the first rail extending through a first opening in the second covering, the second rod extending through a first hole in the first rail; and
a second rail to extend laterally away from the first rod, the second rail extending through a second opening in the first covering, the first rod extending through a second hole in the second rail.

17. An apparatus comprising:
a shaft;
a collar having a cavity to enclose a first portion of the shaft, the collar having an opening to enable a second portion of the shaft to protrude from the collar;
a cup to be mounted to an end of the second portion of the shaft;
a rod to be disposed within the cup; and
a tubular shell to surround the cup and the rod.

18. The apparatus of claim 17, wherein the opening is larger than a diameter of the shaft to permit the shaft to tilt relative to the collar, the cup to be rigidly affixed to the shaft to tilt relative to the collar when the shaft tilts relative to the collar.

19. The apparatus of claim 17, wherein the cup includes a first diameter and the collar includes a second diameter, the second diameter less than the first diameter.

20. The apparatus of claim 19, wherein the cup has a height and a width, the height at least four times the width.
